(19) United States
(12) Patent Application Publication
(10) Pub. No.: US 2008/0197544 A1
(43) Pub. Date: Aug. 21, 2008

(54) HEATING FURNACE AND METHOD FOR MANUFACTURING HONEYCOMB STRUCTURE

(75) Inventors: Takamitsu Saijo, Dunavarsany (HU); Koji Higuchi, Ibi-gun (JP)

Correspondence Address: DITTHAVONG MORI & STEINER, P.C., 918 Prince St., Alexandria, VA, 22314, US

(73) Assignee: IBIDEN CO., LTD., Ogaki (JP)

(21) Appl. No.: 11/967,783

(22) Filed: Dec. 31, 2007

(30) Foreign Application Priority Data
Feb. 21, 2007 (JP) PCT/JP2007/053181

(51) Int. Cl. F27D 19/00; F27D 7/00; B28B 1/00

(52) U.S. Cl. 264/671; 432/247; 432/37

(57) ABSTRACT

A heating furnace for calcining an object to be heated. The heating furnace includes a wall defining a furnace space and configured to receive the object in the furnace space, and a heating device configured to raise a temperature within the furnace space. The heating furnace also includes an oxygen supply channel configured to introduce gases containing oxygen into the furnace space. The oxygen supply channel is formed as an opening in a part of the wall surrounding the furnace space. The heating furnace further includes a gas discharge channel fluidly connected to the furnace space and configured to discharge gases in the furnace space to an outside of the furnace space, and a measurement device installed in the gas discharge channel and configured to measure properties of the gases passing through the gas discharge channel.

### CROSS-REFERENCE TO RELATED APPLICATIONS

The present application claims priority under 35 U.S.C. §119 to PCT Application No. PCT/JP2007/053181, filed Feb. 21, 2007, the contents of which are incorporated herein by reference in their entirety.

### BACKGROUND OF THE INVENTION

1. Field of the Invention

This invention relates to a heating furnace and a method for manufacturing a honeycomb structure.

2. Discussion of the Background

Recently, particulates that are contained in exhaust gases discharged from internal combustion engines of vehicles, such as buses and trucks, and construction machines and the like, have raised serious problems as those particulates are harmful to the environment and the human body. For this reason, there have been proposed various kinds of particulate filters using honeycomb structures made of porous ceramics for capturing the particulates contained in exhaust gases and purifying the exhaust gases. Further, honeycomb structures that allow contact between supported catalysts and exhaust gases to convert nitrogen oxides and the like in exhaust gases have also been known.

With respect to the honeycomb structure of this kind, there has been used a honeycomb structure that is formed by a plurality of rectangular pillar-shaped honeycomb fired bodies manufactured by carrying out treatments such as extrusion molding, degreasing, and firing on ceramics such as silicon carbide and combined with one another by interposing a sealing material layer (adhesive layer) to form the honeycomb structure.

In processes for manufacturing a honeycomb fired body, a degreasing process is a process for decomposing and removing, under an oxygen atmosphere, an organic matter such as a binder in a honeycomb molded body manufactured by an extrusion molding process, and a degreasing furnace is employed in the degreasing process.

Japanese Unexamined Patent Application Publication No. 2002-20174 A describes a continuous degreasing furnace to be employed in the degreasing process. In a case of employing the continuous degreasing furnace, object to be degreased, which moves in a muffle, can be heated so as to carry out the degreasing process.

Japanese Unexamined Patent Application Publication No. 2002-20173 A describes a method for degreasing a silicon carbide molded body by heating under an atmosphere with an oxygen concentration of 1 to 20% in concentrations of gases in a degreasing furnace.

The contents of Japanese Unexamined Patent Application Publication Nos. 2002-20174 A and 2002-20173 A are incorporated herein by reference in their entirety.

### SUMMARY OF THE INVENTION

According to an aspect of the present invention, a heating furnace is advantageously provided for calcining an object to be heated. The heating furnace includes a wall defining a furnace space and configured to receive the object in the furnace space, and a heating device configured to raise a temperature within the furnace space. The heating furnace also includes an oxygen supply channel configured to introduce gases containing oxygen into the furnace space. The oxygen supply channel is formed as an opening in a part of the wall surrounding the furnace space. The heating furnace further includes a gas discharge channel fluidly connected to the furnace space and configured to discharge gases in the furnace space to an outside of the furnace space, and a measurement device installed in the gas discharge channel and configured to measure properties of the gases passing through the gas discharge channel.

In a further aspect of the furnace, the gas discharge channel can be configured to constantly discharge the gases in the furnace space to the outside of the furnace space.

In a further aspect of the furnace, a flow rate of the gases passing through the gas discharge channel can be at least about 10 m³/h and at most about 100 m³/h (Normal).

In a further aspect of the furnace, the measurement device can be a gas concentration sensor. In a still further aspect of the furnace, the measurement device can be an oxygen concentration sensor.

In a further aspect of the furnace, the heating furnace can further include a control device having an input unit configured to input a value measured by the measurement device and an output unit configured to output a control signal, and a furnace atmosphere adjustment device operated in accordance with the control signal output by the output unit on the basis of the measured value, where the furnace atmosphere adjustment device is operated on the basis of the control signal to adjust the properties of the gases in the furnace space.

In a further aspect of the furnace, the wall defining the furnace space can be configured to receive the object that is made of a kneaded material made of inorganic particles and an organic matter kneaded with each other. In a still further aspect of the furnace, the heating device can be configured to heat the organic matter in order to remove the organic matter from the object.

In a further aspect of the furnace, the heating furnace can be configured to be used for degreasing the object.

In a further aspect of the furnace, the wall defining the furnace space can be configured to receive the object that is a pillar-shaped honeycomb molded body obtained by molding a material composition containing a ceramic raw material and an organic matter and having a plurality of cells longitudinally placed in parallel with one another with a cell wall therebetween.

In a further aspect of the furnace, the heating device can be a heater.

In a further aspect of the furnace, the heating device can be configured to heat the temperature in the furnace space to at least about 200 and at most about 600° C.

In a further aspect of the furnace, the heating furnace can further include a gas discharge blower provided in the gas discharge channel as a furnace atmosphere adjustment device.

In a further aspect of the furnace, the heating furnace cab further include: a muffle including the wall; an additional gas discharge channel separately provided from the gas discharge channel, one end of the additional gas discharge channel being connected to a ceiling unit of the muffle, another end of the additional gas discharge channel being connected to the gas discharge channel; and an oxygen sensor installed in the additional gas discharge channel and configured to measure properties of the gases passing through the additional gas discharge channel.

In a further aspect of the furnace, the heating furnace can further include a muffle including the wall, and a gas introduction device configured to adjust an oxygen concentration in the furnace space by introducing gases with a low oxygen concentration into the muffle, where the gas introduction device includes a pipe, a nozzle, a solenoid valve, and a gas supply source.

In a further aspect of the furnace, the heating furnace can be a continuous furnace or a batch type heating furnace.

In a further aspect of the furnace, the measurement device can be configured to measure at least one of a concentration of oxygen, a concentration of alcohol, a concentration of carbon monoxide, a concentration of carbon dioxide, a concentration of steam, and a temperature of the gases.

According to another aspect of the present invention, a method for manufacturing a honeycomb structure formed of a honeycomb fired body is advantageously provided that includes molding a material composition containing a ceramic raw material and an organic matter to manufacture a pillar-shaped honeycomb molded body having a plurality of cells longitudinally placed in parallel with one another with a cell wall therebetween, degreasing the honeycomb molded body by heating the honeycomb molded body in a heating furnace to remove the organic matter from the honeycomb molded body to manufacture a honeycomb degreased body, and firing the honeycomb degreased body to manufacture the honeycomb fired body. The heating furnace used in the degreasing process includes: a wall defining a furnace space for receiving the honeycomb molded body; a heating device for raising a temperature in the furnace space; an oxygen supply channel for introducing gases containing oxygen into the furnace space, formed as an opening in a part of the wall surrounding the furnace space; a gas discharge channel fluidly connected to the furnace space for discharging gases in the furnace space to an outside of the furnace space; and a measurement device installed in the gas discharge channel for measuring properties of the gases passing through the gas discharge channel.

In a further aspect of the method, in the degreasing process, the gas in the furnace space can be constantly discharged to the outside of the furnace space.

In a further aspect of the method, in the degreasing process, a flow rate of the gases passing through the gas discharge channel can be at least about 10 m³/h and at most about 100 m³/h (Normal).

In a further aspect of the method, the measurement device can be a gas concentration sensor. In a still further aspect, the measurement device can be an oxygen concentration sensor.

In a further aspect of the method, the heating furnace can further include: a control device having an input unit for inputting a value measured by the measurement device and an output unit for outputting a control signal; and a furnace atmosphere adjustment device operated in accordance with the control signal output by the output unit on the basis of the measured values. And, the furnace atmosphere adjustment device is operated on the basis of the control signal to adjust the properties of the gases in the furnace space.

In a further aspect of the method, the heating device can be a heater.

In a further aspect of the method, a temperature in the furnace space can be at least about 200 and at most about 600° C.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings:

FIG. 1 is a front view showing a heating furnace of the first embodiment;

FIG. 2 is a cross-sectional view of the heating furnace taken along line A-A in FIG. 1;

FIG. 3(a) is a perspective view schematically showing one example of the honeycomb molded body, and FIG. 3(b) is a cross-sectional view of the honeycomb molded body taken along line B-B in FIG. 3(a);

FIG. 4 is a perspective view schematically showing one example of the honeycomb structure;

FIG. 5 is a magnified figure of the peripheral part of the muffle shown in FIG. 2;

FIG. 6 is a graph showing relationships between the time (minutes) from start of recording and recorded oxygen concentrations (% by volume) in Example 1 and Comparative Example 1;

FIG. 7 is a graph showing relationships between the time (minute) from start of recording and recorded oxygen concentrations (% by volume) in Example 1 and Reference Example 3;

FIG. 8 is a cross-sectional view showing a heating furnace of a second embodiment of the present invention; and

FIG. 9 is a cross-sectional view showing a heating furnace of a third embodiment of the present invention.

### DETAILED DESCRIPTION OF THE EMBODIMENTS

The embodiments will now be described with reference to the accompanying drawings, wherein like reference numerals designate corresponding or identical elements throughout the various drawings.

A heating furnace according to an embodiment of a first aspect of the present invention is a heating furnace for calcining an object to be heated and includes: furnace space for disposing the object to be heated; a heating device for rising in temperature in the furnace space; an oxygen supply channel for introducing gases containing oxygen into the furnace space, formed as an opening in a part of an outer wall surrounding said furnace space; a gas discharge channel connected to the furnace space for discharging gases in the furnace space to an outside of the furnace space; and a measurement device installed in the gas discharge channel for measuring properties of the gases passing through the gas discharge channel.

In the heating furnace according to the embodiment of the first aspect of the present invention, the gases containing oxygen is introduced into the furnace space through the oxygen supply channel and the object to be heated is heated by the heating device, so that components contained in the object to be heated can be oxidized and burned.

Further, since the measurement device for measuring the properties of the gases is installed in the gas discharge channel, the properties of the gases passing through the gas discharge channel can be measured.

Herein, no combustion of the organic matter and the like is caused in the gas discharge channel, and the gases flowing in the gas discharge channel flow to the outside of the furnace space from the inside of the furnace space, so that the gases passing through the gas discharge channel flow more stably with less fluctuation in comparison with the gases in the furnace space.

Since the properties of the gases passing through the gas discharge channel reflect average properties of the gases existing in the furnace space, the measurement of the properties of the gases passing through the gas discharge channel may allow stable detection of the properties of the gases existing in the furnace space.

Accordingly, the use of the heating furnace according to the embodiment of the present invention may allow oxidization and combustion of components contained in the object to be heated while the properties of the gases in the furnace space are stably and properly detected by measuring the properties of the gases flowing through the gas discharge channel.

In this specification, “calcination” means removal of volatile components in a substance by strongly heating the substance in air and includes the concept of degreasing. In this specification, “Normal” means a standard condition for experimental measurements under which pressure is 100 kPa (1 bar) and a temperature is 273.15 K (0° C.). For example, 100 m³/h (Normal) means 100 m³/h at a pressure of 100 kPa (1 bar) and a temperature of 273.15 K (0° C.).

In a heating furnace according to an embodiment of a second aspect of the present invention, the gases in the furnace space is continuously discharged to the outside of the furnace space.

In the heating furnace according to the embodiment of the second aspect of the present invention, since the gases passing through the gas discharge channel continuously flow from the furnace space to the outside of the furnace space, the gases to make contact with the measurement device tends to flow in a definite direction and may allow more stable detection of the properties of the gases in the furnace space.

In a heating furnace according to an embodiment of a third aspect of the present invention, a flow rate of the gases passing through the gas discharge channel is at least about 10 m³/h and at most about 100 m³/h (Normal).

When the flow rate of the gases is about 100 m³/h (Normal) or less, it becomes easy to control the temperature of the object to be heated. On the other hand, when the flow rate is about 10 m³/h (Normal) or more, the evaporated organic matter does not tend to be condensed in the gas discharge channel. In the heating furnace according to the embodiment of the third aspect of the present invention, since the flow rate of the gases is controlled within the above-mentioned range, the properties of the gases in the furnace space tends to be more stably detected.

In a heating furnace according to an embodiment of a fourth aspect of the present invention, the measurement device is a gas concentration sensor, and in a heating furnace according to an embodiment of a fifth aspect of the present invention, the measurement device is an oxygen concentration sensor.

In the heating furnace according to the embodiment of the fourth aspect of the present invention, since the gas concentration of the gases passing through the gas discharge channel can be measured, the extent of the chemical reaction progress during heating tends to be stably detected.

In the heating furnace according to the embodiment of the fifth aspect of the present invention, since the oxygen concentration can be particularly measured, the extent of the oxidation reaction progress caused by heating the object to be heated tends to be stably detected.

A heating furnace according to an embodiment of a sixth aspect of the present invention includes: a control device having an input unit for inputting a value measured by the measurement device and an output unit for outputting a control signal; and a furnace atmosphere adjustment device operated in accordance with the control signal output by the output unit on the basis of the measured value, and adjusts the properties of the gases in the furnace space by operating the furnace atmosphere adjustment device on the basis of the control signal.

In the heating furnace according to the embodiment of the sixth aspect of the present invention, since the measurement device, the control device and the furnace atmosphere adjustment device are installed, the properties of the gases in the furnace space may easily be adjusted by operating the control device and the furnace atmosphere adjustment device on the basis of the value measured by the measurement device so as to preferably control properties of the object material to be manufactured.

In a heating furnace according to an embodiment of a seventh aspect of the present invention, the object to be heated is a kneaded material containing inorganic particles and an organic matter kneaded with each other, and in a heating furnace according to an embodiment of an eighth aspect of the present invention, the organic matter is heated to be removed form the object to be heated.

In the heating furnace according to the embodiments of the seventh and eighth aspects of the present invention, the organic matter may easily be removed by heating the object to be heated while the properties of the gases in the furnace space are stably and properly detected.

Further, in the heating furnace with the control means and furnace atmosphere adjustment device according to the embodiment of the sixth aspect of the present invention, the properties of the gases in the furnace space can be controlled in proper ranges, and the object to be heated containing the inorganic particles and the organic matter can be heated, so that the organic matter contained in the object to be heated may easily be removed at a proper treatment speed with causing less cracks in the object to be heated.

Further, the heating furnace according to an embodiment of a ninth aspect of the present invention may be used for degreasing the object to be heated.

In a heating furnace according to an embodiment of a tenth aspect of the present invention, the object to be heated is a pillar-shaped honeycomb molded body obtained by molding a material composition containing a ceramic raw material and an organic matter and having a plurality of cells longitudinally placed in parallel with one another with a cell wall therebetween. In the heating furnace according to the embodiment of the tenth aspect of the present invention, the honeycomb molded body can be heated while the properties of the gases in the furnace space are stably and properly detected.

Further, in the heating furnace with the control device and furnace atmosphere adjustment device according to the embodiment of the sixth aspect of the present invention, since the properties of the gases in the furnace space can be controlled in proper ranges, the organic matter contained in the honeycomb molded body may be sufficiently decomposed at a proper treatment speed with causing less cracks in the honeycomb molded body.

A method according to an embodiment of a eleventh aspect of the present invention is a method for manufacturing a honeycomb structure formed by the honeycomb fired body and includes: a honeycomb molded body manufacturing process for molding a material composition containing a ceramic raw material and an organic matter to manufacture a pillar-shaped honeycomb molded body having a plurality of cells longitudinally placed in parallel with one another with a cell wall therebetween; a degreasing process for heating the honeycomb molded body in a heating furnace to remove the organic matter from the honeycomb molded body to manufacture a honeycomb degreased body; and a firing process for firing the honeycomb degreased body to manufacture the honeycomb fired body.

The heating furnace used in the degreasing process includes: furnace space for disposing the honeycomb molded body, a heating device for rising in temperature in the furnace space; an oxygen supply channel for introducing gases containing oxygen into the furnace space, formed as an opening in a part of an outer wall surrounding the furnace space; a gas discharge channel connected to the furnace space for discharging gases in the furnace space to an outside of the furnace space; and a measurement device installed in the gas discharge channel for measuring properties of the gases passing through the gas discharge channel.

In the method according to the embodiment of the eleventh aspect of the present invention, the properties of the gases in the furnace space during the degreasing process tends to be stably detected by measuring the properties of the gases passing through the gas discharge channel.

Namely, a honeycomb structure may easily be manufactured while the properties of the gas in the furnace space are stably and properly detected during the degreasing process.

In a method according to an embodiment of a twelfth aspect of the present invention, in the degreasing process, the gases in the furnace space are continuously discharged to the outside of the furnace space.

In the method according to the embodiment of the twelfth aspect of the present invention, since the gases passing through the gas discharge channel continuously flow toward the outside of the furnace space from the furnace space, the gases to make contact with the measurement device flow in a definite direction, so that the honeycomb structure may easily be manufactured while the properties of the gases in the furnace space are more stably detected in the degreasing process.

In a method according to an embodiment of a thirteenth aspect of the present invention, in the degreasing process the flow rate of the gases passing through the gas discharge channel is about 10 to about 100 m³/h (Normal).

When the flow rate of the gases is about 100 m³/h (Normal) or less, it becomes easy to control the temperature of the object to be heated. On the other hand, when the flow rate is about 10 m³/h (Normal) or less, the evaporated organic matter does not tend to be condensed in the gas discharge channel. Since the flow rate of the gases is thus controlled in the above-mentioned range in the method according to the embodiment of the thirteenth aspect of the present invention, the properties of the gases in the furnace space tends to be more stably detected in the degreasing process.

In a method according to an embodiment of a fourteenth aspect of the present invention, the measurement device is a gas concentration sensor and in the method according to an embodiment of a fifteenth aspect of the present invention, the measurement device is an oxygen concentration sensor.

In the method according to the embodiment of the fourteenth aspect of the present invention, since the gas concentration can be measured among the properties of the gases passing through the gas discharge channel, the honeycomb structure may easily be manufactured while the extent of the chemical reaction progress is more stably detected in the degreasing process.

In the method according to the embodiment of the fifteenth aspect of the present invention, since the oxygen concentration can be particularly measured, the honeycomb structure may easily be manufactured while the extent of the oxidation reaction progress caused by heating the honeycomb molded body is stably detected.

In a method according to an embodiment of a sixteenth aspect of the present invention, the heating furnace includes: the control device having an input unit for inputting a value measured by the measurement device and an output unit for outputting a control signal; and the furnace atmosphere adjustment device operated in accordance with the control signal output by the output unit on the basis of the measured value, and the furnace atmosphere adjustment device is operated on the basis of the control signal to adjust the properties of the gases in the furnace space.

In the method according to the embodiment of the sixteenth aspect of the present invention, since the heating furnace to be employed for the degreasing process is provided with the measurement device, the control device and the furnace atmosphere adjustment device, the properties of the gases in the furnace space may easily be adjusted by operating the control device and the furnace atmosphere adjustment device on the basis of the value measured by the measurement device.

Consequently, it becomes easy to manufacture the honeycomb structure by removing the organic matter contained in the honeycomb molded body at a proper treatment speed with causing less cracks on the honeycomb molded body in the degreasing process.

In a degreasing process of JP 2002-20174 A, it is conceivable that it is necessary to control properties of gases in the above-mentioned degreasing furnace, that is, a pressure, a temperature, gas concentrations and the like, in proper ranges.

With respect to the gas concentration, when an oxygen concentration is too high, a generation of a large amount of heat, due to short-term decomposition of a large amount of organic matter, tends to cause abrupt rise in temperature of a honeycomb molded body, sometimes resulting in cracks in the honeycomb molded body. On the other hand, when the oxygen concentration is too low, decomposition of the organic matter tends not to be allowed to proceed, sometimes leading to insufficient progress of degreasing. When firing is carried out under the condition of the insufficient progress of the degreasing, a strength of the honeycomb fired body is sometimes decreased.

In the invention described in JP 2002-20173 A, although gases with a low oxygen concentration are introduced to adjust an oxygen concentration, in order to control the oxygen concentration in a range from 1 to 20%, it is necessary to properly detect the oxygen concentration in the degreasing furnace.

As a method for detecting an oxygen concentration in furnace space, which is space in a degreasing furnace, for disposing a honeycomb molded body therein, there has been employed a method for measuring an oxygen concentration after a certain amount of gases in the furnace space is periodically sampled and then cooled.

However, since gases such as nitrogen, oxygen, and air may be introduced into the furnace space, several kinds of gases sometimes exist to be mixed together in a firing furnace. Further, gases may be generated by combustion of the organic matter and the like in the object to be heated.

A flow of the gases flowing in the furnace space, that is composition of the gases, a direction and a speed of the gas flow and the like, are sometimes significantly fluctuated due to these factors.

Accordingly, under an environment where the flow of the gases flowing in the furnace space in the degreasing furnace is significantly fluctuated, the oxygen concentration in a periphery of a part where the certain amount of the gases are sampled is sometime considerably fluctuated within a short time.

Further, in the case of employing the method for measuring the oxygen concentration in the furnace space by periodically sampling the certain amount of the gases in the furnace space, there is an elapsed time period between the sampling of the gases and the measurement of the concentration.

Therefore, the measured oxygen concentration of the gases does not necessarily properly reflect the oxygen concentration in the furnace space at the time of the measurement, and methods having been employed so far arise a problem that the oxygen concentration in the furnace space may not be properly detected.

The embodiment of the present invention is to provide a heating furnace capable of properly detecting properties of gases in a furnace space in processes requiring heating such as a degreasing process and a method for manufacturing a honeycomb structure, being capable of manufacturing a honeycomb structure by removing an organic matter contained in a honeycomb molded body under proper conditions while the properties of the gases in the furnace space are properly detected during the degreasing process.

### First Embodiment

Hereinafter, a first embodiment of the present invention will be described with reference to drawings.

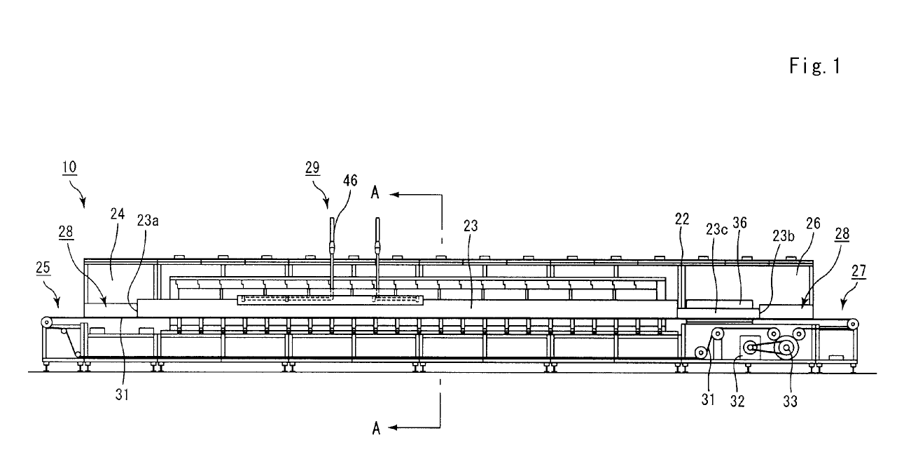

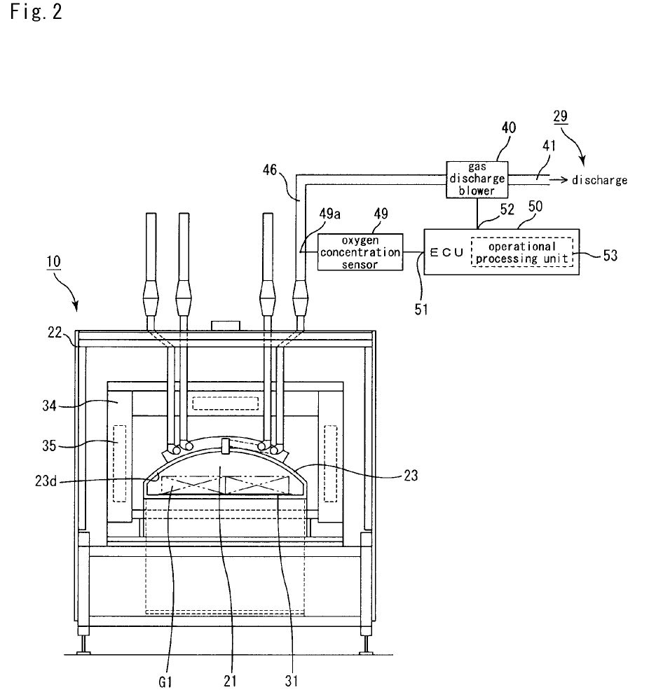

FIG. 1 is a front view showing a heating furnace 10 of the first embodiment of the present invention. FIG. 2 is a cross-sectional view of the heating furnace taken along line A-A in FIG. 1.

The heating furnace 10 shown in FIGS. 1 and 2 is provided with four gas discharge channels 46. FIG. 2 shows only devices such as a measurement devices and a gas discharge blower 40 installed in right-end gas discharge channel, while these devices are installed in the respective gas discharge channels 46, and a mechanism installed in other gas discharge channels are omitted.

The heating furnace 10 shown in FIG. 1 is a continuous furnace. In a transversely long main body frame 22 forming the heating furnace 10, a tubular muffle 23 made of a refractory material is supported transversely in almost all portions except the carrying-in unit 25 and a carrying-out unit 27, and an inlet purge chamber 24 is provided in the periphery of the inlet unit 23a of the muffle 23. The carrying-in unit 25 is provided in a step located forward of the inlet purge chamber 24, that is, in the left side in FIG. 1. On the other hand, an outlet purge chamber 26 is provided in the periphery of an outlet unit 23b of the muffle 23. The carrying-out unit 27 is provided in a step located backward of the outlet purge chamber 26, that is, in the right side in FIG. 1.

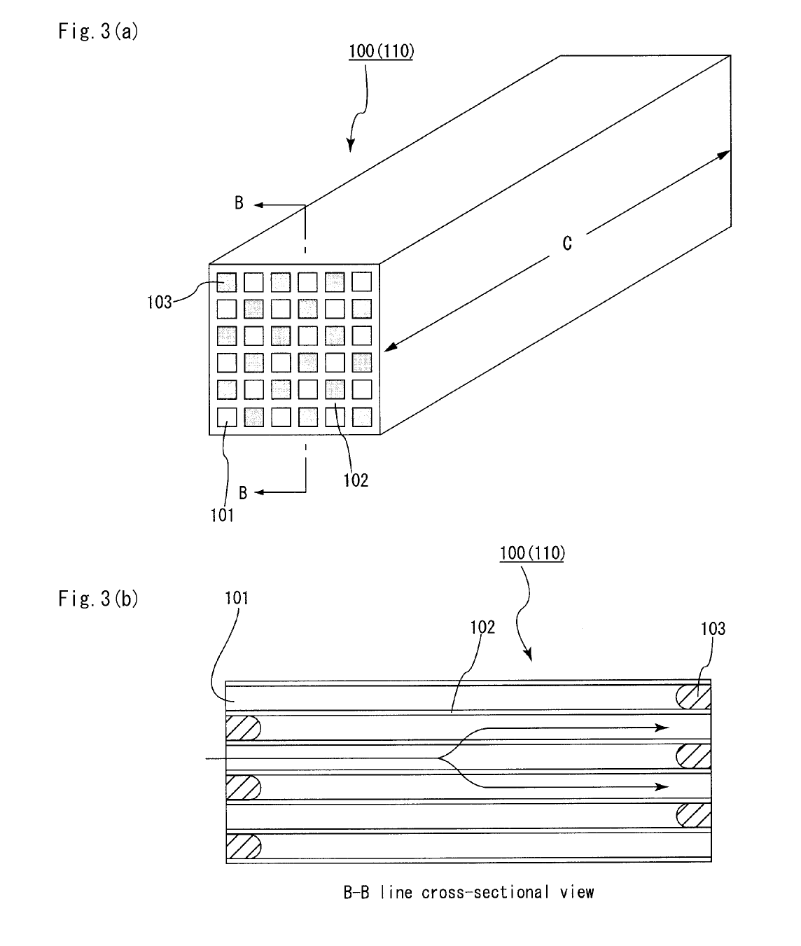

Furnace space 21 is space surrounded with an outer wall formed by the muffle 23 and allows a degreasing jig G1 on which a honeycomb molded body 100 (an object to be heated)(see, e.g., FIGS. 3(a) and 3(b)) is mounted to be installed in the furnace space 21.

In the inside of the muffle 23, a portion of a conveyer belt 31 is laid along the longitudinal direction of the muffle 23, and a conveyer driving unit including a motor 32 and a plurality of pulleys 33 is installed in the lower back side of the muffle 23. The conveyer belt 31 is rolled around the respective pulleys 33.

Driving the motor 32 makes the conveyer belt 31 movable from the inlet unit 23a to the outlet unit 23b, that is, rightward from the left side in FIG. 1. When the motor 32 is driven with an object to be heated on the conveyer belt 31 on the front step located forward of the inlet part 23a, the honeycomb molded body 100 can be transported from the inlet part 23a to the outlet part 23b.

In the outer wall of the muffle 23 surrounding the furnace space 21, the inlet unit 23a and the outlet unit 23b are open, and the main body frame 22 is open from the carrying-in unit 25 to the carrying-out unit 27. Therefore, air containing oxygen is allowed to flow from the inlet unit 23a and the outlet unit 23b to the carrying-out unit 27. As described above, the heating furnace 10 of the present embodiment is provided with an oxygen supply channel 28, which is an open channel connected to the carrying-out unit 27 from the carrying-in unit 25 via the furnace space 21.

The muffle 23 is surrounded with a heat insulating material 34, and a cooling jacket 36, which is cooling device, is provided in a back end unit 23c of the muffle 23.

Further, a gas discharge channel 46 is connected to a ceiling unit 23d of the muffle 23.

As shown in FIG. 2, the heat insulating material 34 is a square-tubular shaped member and is provided to surround the muffle 23, and a heater 35, which works as a heating device, is provided in the inside of the heat insulating material 34.

The heater 35 is for heating the honeycomb molded body 100 moving in the furnace space 21 to rise in temperature thereof up to a predetermined temperature. The cooling jacket 36 is for cooling a high-temperature honeycomb degreased body obtained by degreasing the honeycomb molded body 100 to a normal temperature. By using these devices, the honeycomb molded body 100 can be heated to rise in temperature at which the degreasing can be carried out, and cooled to a normal temperature after the degreasing treatment.

The gas discharge channel 46 is extended from the ceiling unit 23d of the muffle 23 with its one end connected thereto, and the gases in the furnace space 21 are allowed to be discharged to an outside 29 of the furnace space out of the gas discharge channel 46 after passing through a gas discharge unit 41.

Further, a measurement probe 49a of an oxygen concentration sensor 49, which is a measurement device, is provided in the gas discharge channel 46.

A gas discharge blower 40, which is a furnace atmosphere adjustment device, is provided in the middle of the gas discharge channel 46 at a position closer not to the muffle 23 but to the gas discharge unit 41 in relation to a position of the measurement probe 49a.

The oxygen concentration sensor 49 is installed so as to allow the measurement probe 49a and the gases passing through the gas discharge channel 46 to make contact with each other, and electrically connected with an input unit 51 of an electronic control device (hereinafter, referred to as ECU) 50, which is a control device. Therefore, it is possible to measure the oxygen concentration of the gases passing through the gas discharge channel 46 and transmit an obtained measured value to the ECU 50 as an electric signal.

Although not shown in the figure, the oxygen concentration sensor 49 is provided with a display unit for showing the measured oxygen concentration by numeral values.

The ECU 50 is electrically connected to the oxygen concentration sensor 49 at the input unit 51 and the gas discharge blower 40 at the output unit 52. Further, although not in shown the figure, an input mechanism for directly inputting a set value of the oxygen concentration by an operator is also provided. A operational processing unit 53 for calculating the number of revolutions of the gas discharge blower necessary for controlling the oxygen concentration in accordance with the set value of the oxygen concentration and the measured value of the oxygen concentration input in the form of an electric signal is also provided in the inside of the ECU 50.

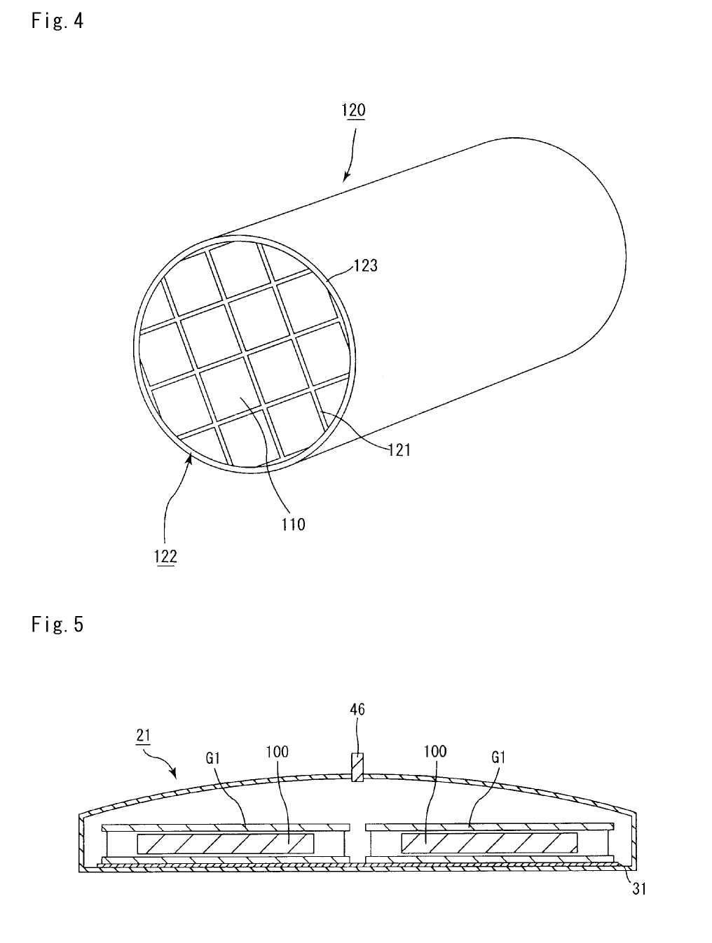

Next, the honeycomb molded body 100, which is an object to be heated, a honeycomb fired body 110 obtained by degreasing and firing the honeycomb molded body, and a honeycomb structure 120, which is an object to be manufactured by the method for manufacturing the honeycomb structure of the present embodiment will be described with reference to FIGS. 3(a) and 3(b) and 4. FIG. 3(a) is a perspective view schematically showing one example of the honeycomb molded body and FIG. 3(b) is a cross-sectional view thereof taken along line B-B in FIG. 3(a).

FIG. 4 is a perspective view schematically showing one example of the honeycomb structure.

As shown in FIG. 3(a), in the honeycomb molded body 100, a large number of cells 101 are longitudinally (direction shown by an arrow C in FIG. 3(a)) placed in parallel with one another and the cells 101 are partitioned by cell walls 102. The cells 101 are sealed by a sealing material 103 at one of the end portions.

The honeycomb fired body 110 is obtained by degreasing and firing the honeycomb molded body 100 of this kind. Since the honeycomb fired body 110 is made of porous ceramics having approximately same shape as that of the honeycomb molded body 100, when exhaust gases flow into one of the cells of the honeycomb fired body 110, the exhaust gases flow out of another cell after certainly passing through the cell wall interposing between the cells. Therefore, when the exhaust gases pass through the cell wall, the particulates in the exhaust gases are captured, resulting in purification of the exhaust gases.

In other words, the cell walls of the honeycomb fired body 110 function as a filter for exhaust gas treatment.

Cutting process is carried out on the periphery of an aggregated body 122, which is formed by a plurality of honeycomb fired bodies 110 combined with one another by interposing a sealing material layer (an adhesive layer) 121, to form a circular cross-section, and a sealing material layer (a coat layer) 123 is formed on the periphery of the aggregated body 122 to manufacture a honeycomb structure 120.

Hereinafter, the method for manufacturing the honeycomb structure of the first embodiment will be described in the order of the processes.

Herein, a method for manufacturing a honeycomb structure in the case of using silicon carbide powders, which is a ceramic raw material, as a main component of constituent materials will be described.

At first, silicon carbide powders having various average particle diameters as a ceramic material and an organic binder are dry blended to prepare a mixed powder, and also a liquid plasticizer, a lubricant and water are mixed to prepare a mixed liquid, and successively the above-mentioned powder mixture and the above-mentioned liquid mixture are wet mixed by using a wet mixing machine to prepare a wet mixture for manufacturing a molded body.

The wet mixture is transported and charged into a molding machine after the preparation.

The wet mixture charged in the extrusion molding machine is formed into a honeycomb molded body having a predetermined shape by extrusion molding. The honeycomb molded body is dried by a microwave drying apparatus, a hot air drying apparatus, a dielectric dryer, a reduced pressure drying apparatus, a vacuum drying apparatus, a freeze drying apparatus and the like to obtain a dried honeycomb molded body.

Next, cutting process to cut the both ends of the manufactured honeycomb molded body by using a cutting machine is carried out to cut the honeycomb molded body into a predetermined length. Subsequently, if necessary, the end portions of the outlet side of the inlet side cell group and the end portions of the inlet side of the outlet side cell group are sealed by filling these parts with a predetermined amount of a sealing material paste to be plugs. Upon sealing the cells, masks for sealing are attached to end faces of the honeycomb molded body (that is, the cut faces after the cutting process) to fill only the cells to be sealed with the plug material paste.

By carrying out such processes, the honeycomb molded body 100, which is an object to be degreased in the degreasing process, is manufactured.

Next, in order to remove the organic matter from the honeycomb molded body in which the plug material paste is filled, the honeycomb molded body is transported to the heating furnace 10 of the present invention, and the degreasing process is carried out to remove the organic matter from the honeycomb molded body 100 to obtain a honeycomb degreased body.

The degreasing process will be described more in detail later.

Next, the manufactured honeycomb degreased body is transported to a firing furnace and the firing process is carried out to manufacture a honeycomb fired body. Processes for applying a sealing material paste to be a sealing material layer (an adhesive layer) to a side face of the obtained honeycomb fired body to form a sealing material paste layer and piling up another honeycomb fired body on the sealing material paste layer are successively and repeatedly carried out to manufacture an aggregated body formed by a predetermined number of honeycomb fired bodies bonded with one another. As the sealing material paste, a material composed of an inorganic binder, an organic binder and inorganic fibers and/or inorganic particles may be used.

Next, the aggregated body of the honeycomb fired bodies is heated to dry and solidify the adhesive paste layers to form sealing material layers (adhesive layers). After that, the aggregated body of the honeycomb fired bodies is cut by a diamond cutter to obtain a ceramic block, a sealing material paste is applied to the periphery face of the ceramic block, and the sealing material paste is dried and solidified to form a sealing material layer (coat layer) to complete a honeycomb structure.

Next, the operation of the heating furnace in the degreasing process for degreasing the honeycomb molded body 100 will be described.

Upon carrying out the degreasing process, before the honeycomb molded body 100 is put into the degreasing furnace 10, electric power is applied to a heater 35, which works as the heating device, to rise in temperature in the heater 35. The heat from the heater 35 rises in temperature of the muffle 23 to keep the temperature in the furnace space 21 suitable for the degreasing process (about 200 to about 600° C.).

FIG. 5 is a magnified figure of the peripheral part of the muffle in FIG. 2.

Upon putting the honeycomb molded body into the degreasing furnace 10, a plurality of honeycomb molded bodies 100 are arranged on the degreasing jig G1 as shown in FIG. 5 to have the longitudinal direction thereof oriented perpendicular to the moving direction of the conveyer belt 31. In the present embodiment, two degreasing jigs G1 are arranged to be in parallel to the width direction of the conveyer belt 31.

Ribs are formed, although not illustrated, on the mounting faces of the degreasing jigs G1 to create a fixed gap between the mounting face of the degreasing jigs G1 and the bottom face of the honeycomb molded bodies 100.

Next, the degreasing jigs G1 on which the honeycomb molded bodies 100 are mounted in such a manner are placed on the conveyer belt 31 in the carrying-in unit 25.

Successively, when the motor 32 is driven, the conveyer belt 31 moves toward the carrying-out unit 27 from the carrying-in unit 25, and therefore the degreasing jigs G1 placed on the conveyer belt 31 are also moved toward the carrying-out part 27.

The degreasing jigs G1 are moved into the furnace space 21 from the inlet unit 23a of the muffle 23 after passing through the inlet purge chamber 24. Along with the movement of the degreasing jigs G1 in the furnace space 21, the temperatures of the degreasing jigs and the honeycomb molded bodies 100 are risen to evaporate the organic matter contained in the honeycomb molded bodies 100, thus the degreasing progresses.

At this time, since the oxygen supply channel 28 is formed in the heating furnace 10 of the present invention, oxygen is continuously supplied to the furnace space 21. Therefore, a part of the evaporated organic matter is reacted with oxygen to be burned. This combustion reaction consumes the organic matter and oxygen and generates reaction gases such as carbon monoxide, carbon dioxide and water vapor.

The evaporated organic matter and the reaction gases are introduced into the gas discharge channel 46 from the ceiling unit 23d of the muffle 23 and discharged out of the discharge outlet 41 through the gas discharge channel 46.

In this case, since the gas discharge blower 40 is installed in the gas discharge channel 46, the gases passing through the gas discharge channel 46 can be controlled to continuously flow in a direction from the furnace space 21 toward the outside of the furnace space by operating the gas discharge blower 40.

The discharged gases pass through the gas discharge channel 46 to make contact with the measurement probe 49a of the oxygen concentration sensor 49 provided in the gas discharge channel 46, so that the oxygen concentration of the gases passing through the gas discharge channel 46 can be measured.

Since the gases passing through the gases discharge channel 46 flow in the definite direction as described above, the gases to make contact with the measurement probe 49a flow in the definite direction, and thus the oxygen concentration can be stably measured.

The oxygen concentration sensor 49 converts the value (electric resistivity etc.) measured by the measurement probe 49a into a proper electric signal and displays the oxygen concentration by numeral values on a display unit. Accordingly, an operator can confirm whether the oxygen concentration is properly controlled in the degreasing process or not.

Further, the oxygen concentration as a measured value is transmitted in the form of an electric signal from the oxygen concentration sensor 49 to the input unit 51 of the ECU 50.

The ECU 50 includes a well known microcomputer formed by CPU, ROM, RAM and the like, which are not illustrated, and a peripheral circuit thereof The ECU 50 has a computation processing unit 53. The computation processing unit 53 carries out computation processing according to a predetermined program on the basis of the set value of the oxygen concentration and the measured value of the oxygen concentration to compute the necessary number of revolutions of the gas discharge blower 40 for controlling the oxygen concentration in the proper range, and outputs a result obtained by the computation processing as a control signal to the gas discharge blower 40, which is the furnace atmosphere adjustment device, from the output unit 52.

The gas discharge blower 40 changes the number of revolutions on the basis of the control signal output from the output unit 52 of the ECU 50.

This configuration allows controlling of the flow rate of the gases passing through the gas discharge channel 46.

Further, the controlled flow rate of the gases passing through the gas discharge channel 46 allows controlling of the oxygen concentration in the furnace space 21.

Further, since the program for calculating the number of revolutions of the gas discharge blower 40 to adjust the flow rate of the gases in a proper range (about 10 to about 100 m³/h (Normal)) is set in the operational processing unit 53, the oxygen concentration in the furnace space 21 can be controlled by controlling the flow rate of the gases passing through the gas discharge channel 46 in the proper range.

Herein, a method for controlling the oxygen concentration in the furnace space 21 will be described more in detail.

In the degreasing process, since the organic matter evaporated from the honeycomb molded body 100 is burned, oxygen in the furnace space 21 is consumed, resulting in reduction of the oxygen concentration in the furnace space 21. In a case where the oxygen concentration becomes too low, the gas discharge blower 40 increase the number of revolutions to increase discharge speed. Accordingly, the inner pressure in the furnace space 21 becomes low, and the amount of the air flowing into the furnace space 21 from the oxygen supply channel 28 is increased, resulting in increase of the oxygen concentration in the furnace space 21.

On the other hand, when the amount of the air flowing into the furnace space 21 through the oxygen supply channel 28 is too much, the oxygen concentration in the furnace space 21 becomes high. In a case where the oxygen concentration becomes too high, the number of revolutions of the gas discharge blower 40 is decreased to decrease the discharge speed. Accordingly, the inner pressure of the furnace space 21 is increased, and the amount of the air flowing into the furnace space 21 through the oxygen supply channel 28 is decreased, resulting in reduction of the oxygen concentration in the furnace space 21.

Since the degreasing jig G1 is moved in the furnace space 21 under a condition where the oxygen concentration in the furnace space 21 is controlled within the proper range, the honeycomb molded body 100 is degreased under the condition of the proper oxygen concentration. When the degreasing jig G1 reaches the back end part 23c of the muffle 23, the degreasing jig G1 and the honeycomb molded body 100 are cooled to a room temperature by the cooling jacket 36.

Thereafter, the degreasing jig reaches the outside of the muffle 23 out of the outlet unit 23b of the muffle 23 and is transported to the outside of the heating furnace 10 out of the carrying-out unit 27 after passing through the outlet purge chamber 26 to complete the degreasing process.

Hereinafter, the effects of the heating furnace of the present embodiment and the method for manufacturing the honeycomb structure by using the heating furnace will be listed.

(1) Since the measurement probe 49a of the oxygen concentration sensor 49, which is the measurement device, is provided in the gas discharge channel 46, the oxygen concentration of the gases passing through the gas discharge channel 46 can be measured. The oxygen concentration of the gases passing through the gas discharge channel 46 reflects the average oxygen concentration of the gases existing in the furnace space 21 of the heating furnace 10, so that the measurement of the oxygen concentration of the gases passing through the gas discharge channel 46 may allow stable and proper detection of the oxygen concentration of the gases existing in the furnace space 21 in the heating furnace 10.

Accordingly, the organic matter contained in the honeycomb molded body 100 may easily be oxidized and burned while the oxygen concentration of the gases in the furnace space 21 in the heating furnace 10 is stably and properly detected by measuring the oxygen concentration of the gases passing through the gas discharge channel 46.

(2) Since the gas discharge blower 40 is installed in the gas discharge channel 46, the gases in the furnace space 21 can be continuously discharged to the outside of the furnace space. When the gases passing through the gas discharge channel 46 is allowed to continuously flow toward the outside 29 of the furnace space from the furnace space 21 as described above, the gases to make contact with the measurement probe 49a tends to flow in the definite direction may allow more stable detection of the oxygen concentration in the furnace space 21.

(3) The flow rate of the gases passing through the gas discharge channel 46 can be controlled in the proper range by adjusting the number of revolutions of the gas discharge blower 40. Controlling the flow rate of the gases passing through the gas discharge channel 46 may prevent condensation of the organic matter in the gases in the gas discharge channel 46 and insufficient temperature control of the object to be heated.

(4) Since the measured value of the oxygen concentration is input to the ECU 50 from the oxygen concentration sensor 49 and the number of revolutions of the gas discharge blower 40 is controlled on the basis of the control signal from the ECU 50, the gas discharge speed of the gases to be discharged out of the furnace space 21 can be adjusted on the basis of the measured value of the oxygen concentration measured in the gas discharge channel 46 and the amount of oxygen to be supplied to the furnace space 21 through the oxygen supply channel 28 can be controlled to adjust the oxygen concentration in the furnace space 21.

Consequently, it becomes easy to sufficiently decompose the organic matter contained in the honeycomb molded body 100 at a proper treatment speed and also to prevent occurrence of cracks in the honeycomb molded body 100.

### EXAMPLES

Hereinafter, Examples more specifically disclosing the first embodiment of the present invention will be described.

### Example 1

A powder mixture was prepared by mixing 250 kg of α-type silicon carbide powder with an average particle diameter of 10 μm, 100 kg of α-type silicon carbide powder with an average particle diameter of 0.5 μm, and 20 kg of an organic binder (methyl cellulose).

Next, separately, a liquid mixture was prepared by mixing 12 kg of a lubricant (UNILUB, manufactured by NOF CORPORATION), 5 kg of a plasticizer (glycerin), and 65 kg of water, and the liquid mixture and the powder mixture were mixed by a wet mixing machine to prepare a wet mixture.

The water content of the prepared wet mixture was 14% by weight.

Next, the wet mixture was transported to an extrusion molding apparatus by using a transportation device and put into the raw material inlet of the extrusion molding device.

The water content of the prepared wet mixture was 13.5% by weight immediately before the putting into the extrusion molding machine.

Thereafter, a raw molded body with an approximately same shape as that of the honeycomb molded body 100 shown in FIG. 3(a) was manufactured by extrusion molding.

Next, after the raw molded body was dried by a microwave drying apparatus, the plug material paste with the same composition as that of the above-mentioned wet mixture was injected into predetermined cells, and the resulting molded body was further dried by the drying apparatus to manufacture a honeycomb molded body 100, which is formed by silicon carbide molded body, having the number of cells (cell density) of 46.5 cells/cm², a size of 34.3 mm×34.3 mm×250 mm and a thickness of the cell wall of 0.30 mm.

Next, the honeycomb molded body 100 was degreased at a temperature of 400° C. by using a heating furnace 10 described in the first embodiment. The specific design of the heating furnace 10 is as follows.

The heating furnace 10 was a continuous furnace, including the muffle 23 with a length of 2.4 m, a width of 0.85 m and a maximum height of 0.15 m, and the furnace space 21 with a total capacity of 2.7 m³.

Four gas discharge channels 46 stood uprightly from the muffle 23 and were circular tubes with a diameter of 0.1 m.

A measurement probe 49a of an oxygen concentration sensor 49 was provided at a position of 1 m distant from the ceiling unit 23d of the muffle 23 toward the gas discharge unit side in each gas discharge channel 46.

The degreasing process was carried out according to the following procedure by using the heating furnace 10.

At first, electric power was applied to the heater 35, and the temperature of the heater 35 is risen to adjust the temperature in the furnace space 21 to be 400° C. Further, the motor 32 was driven to move the conveyer belt 31 in a direction from the carrying-in unit 25 to the carrying-out unit 27.

At that time, the moving speed of the conveyer belt 31 was 140 mm/min.

A large number of degreasing jigs G1 each housing ten honeycomb molded bodies 100 were prepared.

In the carrying-in unit 25 of the heating furnace 10, the degreasing jigs G1 arranged along the proceeding direction of the conveyer belt 31 were placed on the conveyer belt 31, and the degreasing jigs G1 were successively introduced into the furnace space 21 of the muffle 23 to continuously carry out the degreasing treatment for the honeycomb molded bodies 100.

While the set value of the oxygen concentration to be input to the ECU 50 was determined to be 10% by volume, the oxygen concentrations in the gas discharge channels 46 were measured by the oxygen concentration sensors 49, and on the basis of the measured oxygen concentration, the number of revolutions of the gas discharge blower 40 was controlled to adjust the oxygen concentration in the furnace space 21.

Further, the flow rate of the gases passing through the gas discharge channels 46 was continuously operated according to a program set in the operational processing unit 53 to adjust the flow rate in a range from 10 to 100 m³/h (Normal), and the gases were continuously discharged to the outside 29 of the furnace space 21.

The degreasing jigs G1 housing the honeycomb degreased bodies were taken out to the outside out of the carrying-out unit 27 to complete the degreasing process.

Subsequently, the honeycomb degreased bodies were fired at a temperature of 2200° C. for 3 hours in an argon atmosphere at a normal pressure to complete the manufacture of honeycomb fired bodies formed by silicon carbide sintered bodies.

### Reference Example 1

The degreasing process was carried out in the same manner as Example 1 to manufacture honeycomb fired bodies, except that the program set in the computation processing unit 53 was changed to adjust the flow rate of the gases passing through the gas discharge channels 46 in a range of 5 to 100 m³/h (Normal), and the gas discharge blower 40 was continuously operated according to this program.

### Reference Example 2

The degreasing process was carried out in the same manner as Example 1 to manufacture honeycomb fired bodies, except that the program set in the operational processing unit 53 was changed to adjust the flow rate of the gases passing through the gas discharge channels 46 in a range of 10 to 120 m³/h (Normal), and the gas discharge blower 40 was continuously operated according to this program.

### Reference Example 3

The degreasing process was carried out in the same manner as Example 1 to manufacture honeycomb fired bodies, except that the program set in the operational processing unit 53 was changed to control the ON-OFF of revolutions of the gas discharge blower 40 instead of controlling the number of revolutions of the gas discharge blower upon controlling the oxygen concentration, and the gas discharge blower 40 was not continuously operated according to of this program.

### Comparative Example 1

A probe of an oxygen concentration sensor was additionally provided in the furnace space 21 of the heating furnace 10 used in Example 1 to manufacture a heating furnace.

The position of the measurement probe of the additionally installed oxygen concentration sensor was a position extruded by 1 cm inward in the furnace space 21 from the ceiling unit 23d of the muffle 23 and shifted by 0.2 m in the direction (the right side in FIG. 2) of the side face of the muffle 23 from the highest point of the ceiling unit 23d of the muffle 23.

Since the additionally installed oxygen concentration sensor was not connected to the ECU 55, the additionally installed oxygen concentration sensor had only a function of exclusively measuring the oxygen concentration in the furnace space 21.

Namely, the heating furnace was allowed to measure the oxygen concentrations simultaneously in the gas discharge channels 46 and also in the furnace space 21 to control the oxygen concentration on the basis of the results of the measured oxygen concentration of the gases flowing through the gas discharge channels 46.

The degreasing process was carried out in the same manner as Example 1 by using this heating furnace to manufacture honeycomb fired bodies.

(Evaluation of Recorded Results of Oxygen Concentration in the Degreasing Process)

In the degreasing processes of Example 1, Reference Examples 1 to 3 and Comparative Example 1, the oxygen concentrations were measured by the oxygen concentration sensors installed in respective heating furnaces and recorded to evaluate the spread of the measured values of the oxygen concentrations.

Specifically, the degreasing jigs G1 housing the honeycomb molded bodies 100 were successively introduced into the heating furnace, the heating furnace was continuously operated, and after 60 minutes from the operation, the oxygen concentrations were recorded at every 1 minute for 150 minutes.

The conditions for recording the oxygen concentrations and the average values and variation of the results recorded in all of Example, Reference Examples, and Comparative Example are shown in Table 1.

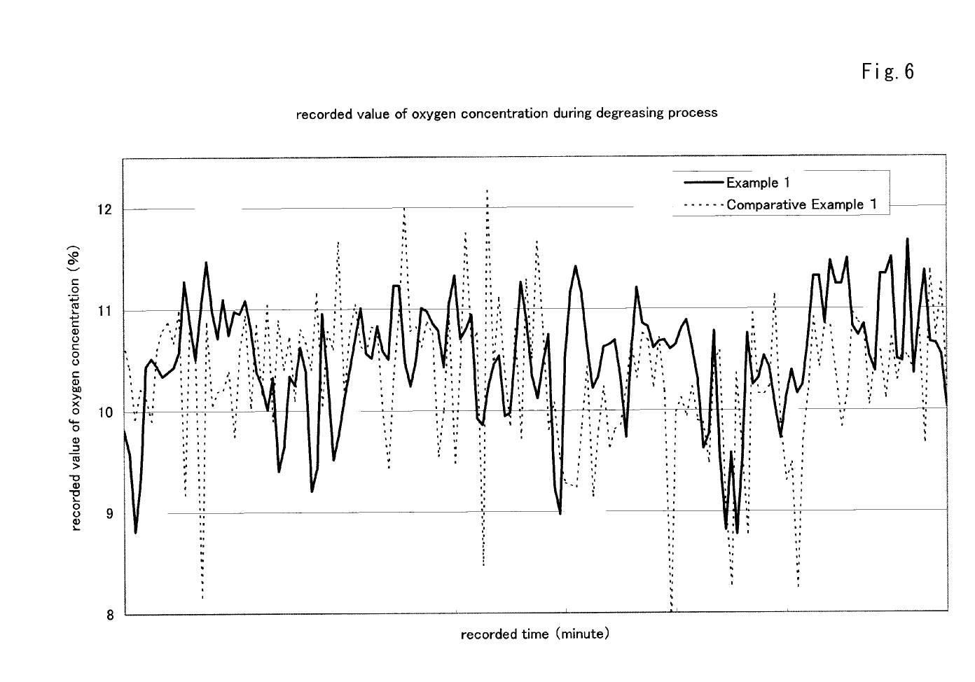

Further, the relationships of the time (minute) from start of the recording with the oxygen concentrations (% by volume) recorded in Example 1 and Comparative Example 1 are shown in FIG. 6.

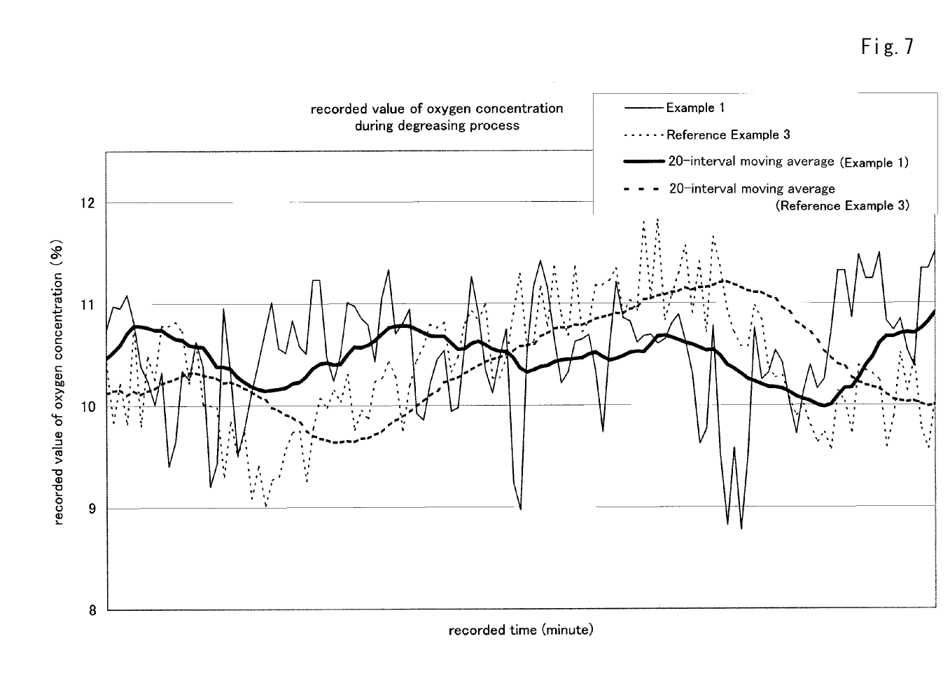

Further, the relationships of the time (minute) from start of the recording with the oxygen concentrations (% by volume) recorded in Example 1 and Reference Example 3 are shown in FIG. 7. FIG. 7 also shows interval moving average curves for every 20 minutes of the oxygen concentrations.

Although, in Comparative Example 1, the oxygen concentrations were measured simultaneously by the oxygen concentration sensor with the measurement probes thereof provided in both of the furnace space 21 and the gas discharge channels 46, Table 1 and FIG. 6 show the recorded results of oxygen concentration measured in the furnace space 21.

Although the measurement and recording of the oxygen concentrations were carried out in all the four gas discharge channels 46, Table 1, FIG. 6, and FIG. 7 show the measured values by the sensor installed in the right side gas discharge channel 46 (the gas discharge channel where the temperature became highest) in FIG. 1.

TABLE 1

| | Installation | Oxygen | | | | | |
|---|---|---|---|---|---|---|---|
| | position of | concentration | Flow | | Oxygen | | |
| | the oxygen | measurement | rate | | concentration | | |
| | concentration | position for | [m³/h | Continuous | recorded value | | |
| | sensor | recording | (Normal)] | discharge | (vol %) | max − min | Notes |
| Example 1 | gas discharge | gas discharge | 10-100 | YES | 8.8 to 11.6 | 2.8 | — |
| | channel | channel | | | | | |
| Reference | gas discharge | gas discharge | 5-100 | YES | 8.6 to 11.4 | 2.8 | organic matter |
| Example 1 | channel | channel | | | | | condensed in gas |
| | | | | | | | discharge |
| | | | | | | | channel |
| Reference | gas discharge | gas discharge | 10-120 | YES | 9.2 to 12.0 | 2.8 | Insufficient |
| Example 2 | channel | channel | | | | | temperature |
| | | | | | | | control in molded |
| | | | | | | | body |
| Reference | gas discharge | gas discharge | 0-100 | NO | 9.1 to 11.8 | 2.7 | organic matter |
| Example 3 | channel | channel | | | | | condensed in gas |
| | | | | | | | discharge |
| | | | | | | | channel |
| Comparative | furnace | furnace | 10-100 | YES | 8.0 to 12.2 | 4.2 | same state in |
| Example 1 | space/gas | space | | | | | furnace space as |
| | discharge | | | | | | that of Example 1 |
| | channel | | | | | | |

As clearly shown in Table 1 and FIG. 6, since the oxygen concentrations were measured in gas discharge channels in Example 1 and Reference Examples 1 to 3, the spreads of the recorded values of the oxygen concentrations were small (the effect (1)). On the other hand, in Comparative Example 1, since the oxygen concentration was measured in the furnace space, the spread of the recorded values of the oxygen concentrations was large.

In particular, in comparison of Example 1 with Comparative Example 1, although practical conditions in the furnace space were supposed to be same, the spreads of the recorded values considerably differed from each other. Accordingly, it became clear that stable measured values can be obtained by measuring the oxygen concentration in the gas discharge channels, leading to proper detection of oxygen concentrations (effect (1)).

Further, as clearly shown in FIG. 7, since the gases in the furnace space were continuously discharged to the outside of the furnace space in Example 1, it is understood that the interval moving average curve could be less undulating as compared with that of Reference Example 3 in which the gases in the furnace space were not continuously discharged to the outside of the furnace space. Accordingly, it became clear that the oxygen concentration in the furnace space 21 can be more stably detected (effect (2)).

Further, in Example 1, since the flow rate of the gases passing through the gas discharge channels was controlled in the proper range, the organic matter was not condensed in the gas discharge channels, and the degreasing of the honeycomb molded bodies was sufficiently progressed (effect (3)).

On the other hand, in Reference Examples 1 and 3, the flow rates of the gases passing through the gas discharge channels were sometimes less than 10 m³/h (Normal), and it was observed that a part of the organic matter was condensed in the gas discharge channels.

Further, in Reference Example 2, the flow rate of the gases passing through the gas discharge channels sometimes exceeded 100 m³/h (Normal), and the temperature of the honeycomb molded bodies, which is the objects to be heated, was not sufficiently controlled, so that the degreasing of the honeycomb molded bodies was sometimes insufficiently carried out.

### The Second Embodiment

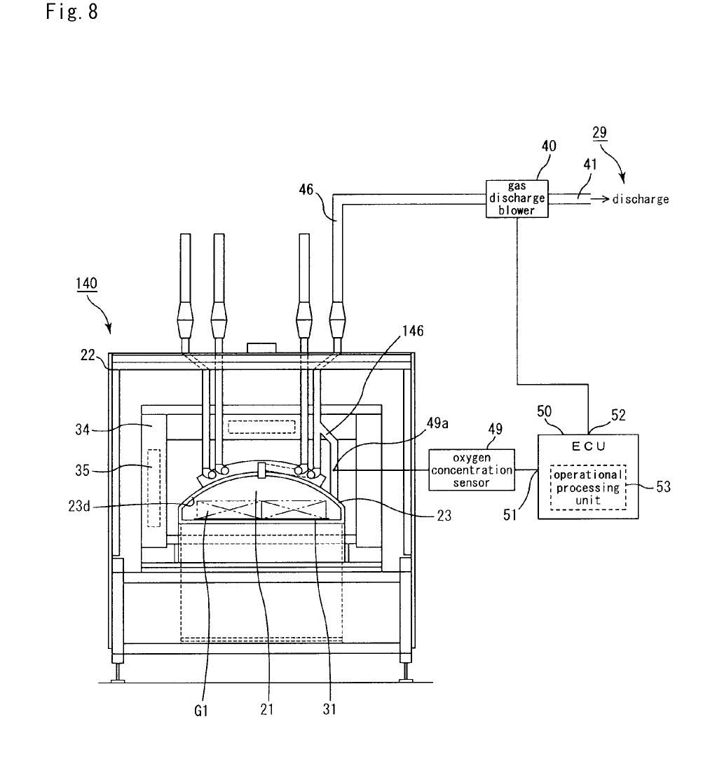

FIG. 8 is a schematic cross-sectional view showing a part of a heating furnace of another embodiment of the present invention.

In a heating furnace 140 of the present embodiment, a gas discharge channel 146 for measurement is separately provided from the gas discharge channels 46. One end of the gas discharge channel 146 for measurement is connected to the ceiling unit 23d of the muffle 23 and the other end is connected to a gas discharge channel 46. An oxygen sensor 49a is installed in the gas discharge channel 146 for measurement.

In the heating furnace 140 of the present embodiment, the oxygen concentration of the gases passing through the gas discharge channel 146 for measurement can be measured. The gases passing through the gas discharge channel 146 for measurement flow more stably, compared with the gases in the furnace space 21, so that the oxygen concentration tends to be stably measured.

Further, since the oxygen concentration can be controlled on the basis of the measured oxygen concentration, the oxygen concentration tends to be adjusted in the proper range.

Accordingly, also in the heating furnace having such a configuration, the measurement and control of the oxygen concentration can be carried out similarly to the case of the heating furnace of the first embodiment and the effects (1) to (4) can be produced also in the present embodiment.

### Third Embodiment

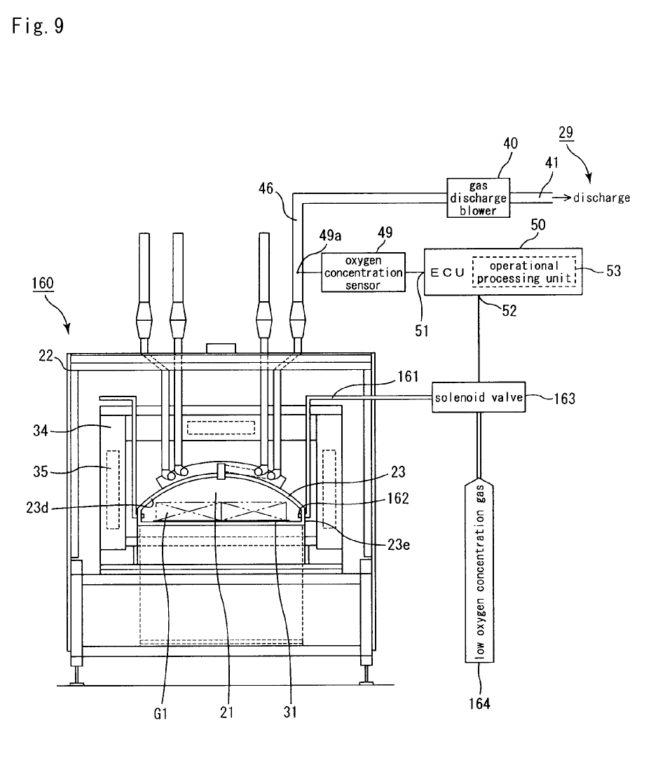

FIG. 9 is a schematic cross-sectional view showing a part of the heating furnace of another embodiment of the present invention.

In a heating furnace 160 of the present embodiment, in place of a gas discharge blower 40 used as the furnace atmosphere adjustment device, gas introduction device for adjusting the oxygen concentration by introducing gases with a low oxygen concentration into the muffle is used. The gas introduction device includes a pipe 161, a nozzle 162, a solenoid valve 163, and a gas supply source 164.

In the heating furnace 160, unlike the heating furnace 10 shown in the first embodiment, the output unit 52 of the ECU 50 is connected to the solenoid valve 163 but not connected electrically to the gas discharge blower 40.

In the gas introduction device, the pipe 161 is provided with the nozzle 162 on one end of the pipe 161 and the nozzle 162 is connected to a sidewall unit 23e of the muffle 23. The other end of the pipe 161 is connected to the gas supply source 164 through the solenoid valve 163.

The gas supply source 164 stores low oxygen concentration gases, which is a gas mixture containing nitrogen and oxygen, is introduced into the muffle 23, that is, the furnace space 21, from the nozzle 162 after passing through the pipe 161.

The solenoid valve 163 is electrically connected to the output unit 52 of the ECU 50 and the aperture can be adjusted on the basis of the control signal output from the ECU 50.

The flow rate of the low oxygen concentration gas to be introduced into the furnace space 21 from the gas supply source 164 after passing through the solenoid valve 163, the pipe 161 and the nozzle 62, can be adjusted by adjusting the aperture of the solenoid valve 163. As described above, the oxygen concentration in the furnace space 21 can be adjusted by operating the solenoid valve 163.

Specifically, in a case where the oxygen concentration in the furnace space 21 is high, the aperture of the solenoid valve 163 is increased to introduce the low oxygen concentration gases into the furnace space 21 from the gas supply source 164 to lower the oxygen concentration in the furnace space 21.

On the contrary, in a case where the oxygen concentration in the furnace space 21 is low, the aperture of the solenoid valve 163 is decreased to introduce a less amount of the low oxygen concentration gases into the furnace space 21 from the gas supply source 164 to increase the oxygen concentration in the furnace space 21.

Accordingly, the effects (1) to (3) can be produced also in the present embodiment. Further, it is also possible to adjust the oxygen concentration in the furnace space 21 by adjusting an amount of the low oxygen concentration gases to be supplied to the furnace space 21 from the gas supply source 164 on the basis of the measured value of the oxygen concentration measured in the gas discharge channels 46.

Consequently, it becomes easy to sufficiently decompose the organic matter contained in the honeycomb molded bodies 100 at a proper treatment speed in the degreasing process and to prevent occurrence of cracks on the honeycomb molded bodies 100.

### Fourth Embodiment

Although not particularly illustrated, the heating furnace of the present embodiment employs both of the gas discharge blower 40 described in the first embodiment and gas introduction device described in the third embodiment. In the heating furnace of the present embodiment, both of the gas discharge blower 40 and a solenoid valve 163 are connected to an output unit 52 of an ECU 52, and both of the gas discharge blower 40 and the solenoid valve 163 are operated by the control signal output from the output unit 52 of the ECU 50 to adjust the oxygen concentration in the furnace space 21.

Accordingly, it is possible to produce the effects (1) to (4) also in the present embodiment, and it becomes easy to sufficiently decompose the organic matter contained in the honeycomb molded bodies 100 at a proper treatment speed in the degreasing process and to prevent occurrence of cracks on the honeycomb molded bodies 100.

### Another Embodiment

The heating furnace in the first embodiment and the method for manufacturing a honeycomb structure may be as follows.

The heating furnace may be a batch type heating furnace other than the continuous furnace as shown in FIG. 1.

Even in a case of employing the batch type heating furnace, a muffle, gas discharge channel, measurement device, control device, and furnace atmosphere adjustment device similar to those in the heating furnace 10 of the first embodiment can be installed. The heating furnace and respective units thereof desirably have shapes and sizes enabling an operator to put into or taken out the degreasing jigs G1 by manual.

In a case of carrying out the degreasing process using the batch type heating furnace, instead of the continuous putting-into and taken-out of the degreasing jigs G1 using the conveyer belt, a predetermined number of the degreasing jigs G1 may be put into the furnace space and taken out upon completion of the degreasing process by manual, and other degreasing jigs G1 are put into the furnace space again, thus the degreasing process can be carried out by repeating these steps.

Even in the case of such a batch type heating furnace, the properties of the gases in the heating furnace can be detected properly by installing the measurement device in the gas discharge channels.

Further, the properties of the gases measured in the gas discharge channels are not limited to the oxygen concentration, but may be the concentration of another gas, for example, a concentration of alcohol, which is an organic matter evaporated from the honeycomb molded body, or the concentrations of carbon monoxide, carbon dioxide and steam generated by combustion of the organic matter, the temperature of the gases or the like.

A plurality of properties may be simultaneously measured by installing a plurality of measurement devices.

The heating furnace 10 shown in FIGS. 1 and 2 includes four gas discharge channels 46, and measurement probes 49a are installed in the respective gas discharge channels 46, however the measurement probes 49a may be installed in only some of the gas discharge channels 46.

Even in such a case, the properties of the gases passing through the gas discharge channels 46 can be measured and the properties of the gases existing in the furnace space 21 can be stably detected.

Further, the device for discharging the gases to the outside of the furnace space is not necessarily limited to the gas discharge blower, and a device such as a gas discharge fan and a vacuum pump may be employed.

The honeycomb structure to be manufactured in the embodiment is not limited to a honeycomb structure with sealed cells. The honeycomb structure with sealed cells can be preferably used as a honeycomb filter, and the honeycomb structure with unsealed cells can be preferably used as a catalyst supporting carrier.

Accordingly, in the method for manufacturing a honeycomb structure of the present embodiments, filling of a plug material paste is not necessarily carried out, and if necessary, the filling may be carried out.

The main component of the constituting materials of the honeycomb structure is not limited to silicon carbide, and examples of other ceramic raw materials include inorganic powders: a nitride ceramics such as aluminum nitride, silicon nitride, boron nitride, and titanium nitride; a carbide ceramics such as zirconium carbide, titanium carbide, tantalum carbide, and tungsten carbide; and an oxide ceramics such as alumina, zirconia, cordierite, mullite, and aluminum titanate, and the like.

Among these, a non-oxide ceramics is preferably used and silicon carbide is more preferably used. This is because these ceramics are superior in the heat resistance, mechanical strength, thermal conductivity and the like. Moreover, silicon-containing ceramics such as metallic silicon blended with the above-mentioned ceramics and ceramics bound by silicon or silicate compounds can also be used as the constituting material of the honeycomb structure. Among these, a ceramics (silicon-containing silicon carbide) in which metallic silicon is blended with silicon carbide is preferably used.

Although the particle diameter of the silicon carbide powder used for manufacturing the honeycomb structure is not particularly limited, the silicon carbide powder that tends not to cause the case where the size of the honeycomb fired body manufactured by the following firing treatment becomes smaller than that of the honeycomb degreased body is desirable, and for example, mixed powder, prepared by combining 100 parts by weight of ceramic particles having an average particle diameter from about 0.3 to about 50 μm with about 5 to about 65 parts by weight of ceramic particles having an average particle diameter from about 0.1 to about 1.0 μm, is preferably used.

In order to adjust the particle diameter and the like of the honeycomb structure, it is necessary to control the firing temperature. However, the particle diameter can be adjusted by adjusting the particle diameter of the inorganic powders.

The organic binder for the wet mixture is not particularly limited, and examples thereof include methyl cellulose, carboxymethyl cellulose, hydroxyethyl cellulose, polyethylene glycol and the like. Among these, methyl cellulose is preferably used. Ordinarily, an amount of the organic binder to be mixed is preferably about 1 with respect to about 10 parts by weight to 100 parts by weight of the inorganic powders.

The plasticizer for the wet mixture is not particularly limited, and examples thereof include glycerin and the like.

In addition, the lubricant is not particularly limited, and examples thereof include polyoxyalkylene compounds such as polyoxyethylene alkyl ether and polyoxypropylene alkyl ether, and the like.

Specific examples of the lubricant include polyoxyethylene monobutyl ether, polyoxypropylene monobutyl ether and the like.

The plasticizer and the lubricant may not be added to the mixed raw material powders in some cases.

In the case of preparing the wet mixture, a dispersant solution may be used, and examples of the dispersant solution include water, organic solvent such as benzene, alcohol such as methanol, and the like.

The wet mixture may contain a molding assistant.

As the molding assistant, although not particularly limited, examples thereof include ethylene glycol, dextrin, fatty acid, fatty acid soap, polyalcohol and the like.

A pore-forming agent, such as balloons that are fine hollow spheres composed of oxide-based ceramics or spherical acrylic particles, graphite and the like, may be added to the wet mixture, if necessary.

As the balloons, although not particularly limited, examples thereof include alumina balloons, glass micro-balloons, shirasu balloons, fly ash balloons (FA balloons), mullite balloons and the like. Among these, alumina balloons are preferably used.

The wet mixture prepared by containing the silicon carbide powder is preferable at a temperature of about 28° C. or less. It is because the organic binder may sometimes become gel, when the temperature is too high.

The percentage of the organic matter contained in the wet mixture is preferably about 10% by weight or less, and the content of water is preferably about 8.0 to about 20.0% by weight.

Although the plug material paste for sealing the cells is not particularly limited, a plug material paste on which post-process are carried out to form a plug having a porosity of about 30 to about 75% is preferably used, and, for example, those same as the wet mixture may be used.

Upon manufacturing an aggregated body of honeycomb fired bodies, the honeycomb fired bodies may be previously built up by interposing a spacer therebetween, and thereafter, a sealing material paste is injected into a gap between neighboring honeycomb fired bodies to manufacture the aggregated body of honeycomb fired bodies.

As the inorganic binder in the sealing material paste, examples thereof include silica sol, alumina sol and the like.

Each of these may be used alone, or two or more kinds of these may be used in combination. Among these inorganic binders, silica sol is preferably used.

As the organic binder in the sealing material paste, examples thereof include polyvinyl alcohol, methyl cellulose, ethyl cellulose, carboxymethyl cellulose and the like. Each of these may be used alone, or two or more kinds of these may be used in combination. Among these, organic binders, carboxymethyl cellulose is preferably used.

As the inorganic fibers in the sealing material paste, examples thereof include ceramic fibers such as silica-alumina, mullite, alumina and silica, and the like. Each of these may be used alone, or two or more kinds of these may be used in combination. Among these inorganic fibers, almina fiber is preferably used.

As the inorganic particles in the sealing material paste, examples thereof include carbides, nitrides and the like. Specific examples thereof include inorganic powders made from silicon carbide, silicon nitride, and boron nitride, and the like. Each of these may be used alone, or two or more kinds of these may be used in combination. Among inorganic particulates, silicon carbide superior in thermal conductivity is preferably used.

Furthermore, a pore-forming agent, such as balloons that are fine hollow spheres composed of oxide-based ceramics or spherical acrylic particles, graphite and the like, may be added to the sealing material paste, if necessary. As the balloons, although not particularly limited, examples thereof include alumina balloons, glass micro-balloons, shirasu balloons, fly ash balloons (FA balloons), mullite balloons and the like. Among these, alumina balloons are preferably used.

Obviously, numerous modifications and variations of the present invention are possible in light of the above teachings. It is therefore to be understood that within the scope of the appended claims, the invention may be practiced otherwise than as specifically described herein.

1. A heating furnace for calcining an object to be heated, said heating furnace comprising:
a wall defining a furnace space and configured to receive the object in said furnace space;
a heating device configured to raise a temperature within said furnace space;
an oxygen supply channel configured to introduce gases containing oxygen into said furnace space, said oxygen supply channel being formed as an opening in a part of said wall surrounding said furnace space;
a gas discharge channel fluidly connected to said furnace space and configured to discharge gases in said furnace space to an outside of said furnace space; and
a measurement device installed in said gas discharge channel and configured to measure properties of the gases passing through said gas discharge channel.

2. The heating furnace according to claim 1, wherein said gas discharge channel is configured to constantly discharge the gases in said furnace space to the outside of said furnace space.

3. The heating furnace according to claim 1, wherein a flow rate of the gases passing through said gas discharge channel is at least about 10 m³/h and at most about 100 m³/h (Normal).

4. The heating furnace according to claim 1, wherein said measurement device is a gas concentration sensor.

5. The heating furnace according to claim 4, wherein said measurement device is an oxygen concentration sensor.

6. The heating furnace according to claim 1, further comprising:
a control device having an input unit configured to input a value measured by said measurement device and an output unit configured to output a control signal; and
a furnace atmosphere adjustment device operated in accordance with the control signal output by said output unit on the basis of the measured value,
wherein said furnace atmosphere adjustment device is operated on the basis of said control signal to adjust the properties of the gases in said furnace space.

7. The heating furnace according to claim 1, wherein said wall defining said furnace space is configured to receive the object that is made of a kneaded material made of inorganic particles and an organic matter kneaded with each other.

8. The heating furnace according to claim 7, wherein said heating device is configured to heat the organic matter in order to remove the organic matter from the object.

9. The heating furnace according to claim 1, wherein said heating furnace is configured to be used for degreasing the object.

10. The heating furnace according to claim 1, wherein said wall defining said furnace space is configured to receive the object that is a pillar-shaped honeycomb molded body obtained by molding a material composition containing a ceramic raw material and an organic matter and having a plurality of cells longitudinally placed in parallel with one another with a cell wall therebetween.

11. The heating furnace according to claim 1, wherein said heating device is a heater.

12. The heating furnace according to claim 1, wherein said heating device is configured to heat the temperature in said furnace space to at least about 200 and at most about 600° C.

13. The heating furnace according to claim 1, further comprising:
a gas discharge blower provided in said gas discharge channel as a furnace atmosphere adjustment device.

14. The heating furnace according to claim 1, further comprising:
a muffle including said wall;
an additional gas discharge channel separately provided from said gas discharge channel, one end of said additional gas discharge channel being connected to a ceiling unit of said muffle, another end of said additional gas discharge channel being connected to said gas discharge channel; and
an oxygen sensor installed in said additional gas discharge channel and configured to measure properties of the gases passing through said additional gas discharge channel.

15. The heating furnace according to claim 1, further comprising:
a muffle including said wall; and
a gas introduction device configured to adjust an oxygen concentration in said furnace space by introducing gases with a low oxygen concentration into said muffle, said gas introduction device comprising a pipe, a nozzle, a solenoid valve, and a gas supply source.

16. The heating furnace according to claim 1, wherein said heating furnace is a continuous furnace or a batch type heating furnace.

17. The heating furnace according to claim 1, wherein said measurement device is configured to measure at least one of a concentration of oxygen, a concentration of alcohol, a concentration of carbon monoxide, a concentration of carbon dioxide, a concentration of steam, and a temperature of the gases.

18. A method for manufacturing a honeycomb structure formed of a honeycomb fired body, said method comprising:
molding a material composition containing a ceramic raw material and an organic matter to manufacture a pillar-shaped honeycomb molded body having a plurality of cells longitudinally placed in parallel with one another with a cell wall therebetween;
degreasing the honeycomb molded body by heating the honeycomb molded body in a heating furnace to remove the organic matter from the honeycomb molded body to manufacture a honeycomb degreased body; and
firing the honeycomb degreased body to manufacture the honeycomb fired body,
wherein the heating furnace used in the degreasing process includes:
a wall defining a furnace space for receiving the honeycomb molded body;
a heating device for raising a temperature in the furnace space;
an oxygen supply channel for introducing gases containing oxygen into the furnace space, formed as an opening in a part of the wall surrounding the furnace space;
a gas discharge channel fluidly connected to the furnace space for discharging gases in the furnace space to an outside of the furnace space; and
a measurement device installed in the gas discharge channel for measuring properties of the gases passing through the gas discharge channel.

19. The method for manufacturing a honeycomb structure according to claim 18, wherein, in the degreasing process, the gas in the furnace space is constantly discharged to the outside of the furnace space.

20. The method for manufacturing a honeycomb structure according to claim 18, wherein, in the degreasing process, a flow rate of the gases passing through the gas discharge channel is at least about 10 m³/h and at most about 100 m³/h(Normal).

21. The method for manufacturing a honeycomb structure according to claim 18, wherein the measurement device is a gas concentration sensor.

22. The method for manufacturing a honeycomb structure according to claim 21, wherein the measurement device is an oxygen concentration sensor.

23. The method for manufacturing a honeycomb structure according to claim 18, wherein the heating furnace further includes:
a control device having an input unit for inputting a value measured by the measurement device and an output unit for outputting a control signal; and
a furnace atmosphere adjustment device operated in accordance with the control signal output by the output unit on the basis of the measured values, and
wherein the furnace atmosphere adjustment device is operated on the basis of the control signal to adjust the properties of the gases in the furnace space.

24. The method for manufacturing a honeycomb structure according to claim 18, wherein the heating device is a heater.

25. The method for manufacturing a honeycomb structure according to claim 18, wherein a temperature in the furnace space is at least about 200 and at most about 600° C.
